(19) United States
(12) Patent Application Publication
(10) Pub. No.: US 2005/0095181 A1
(43) Pub. Date: May 5, 2005

(54) Mixing and reaction of solids, suspensions or emulsions in a microwave field

(75) Inventor: Werner Lautenschlager, Leutkirch (DE)

Correspondence Address: MARSHALL, GERSTEIN & BORUN LLP, 6300 SEARS TOWER, 233 S. WACKER DRIVE, CHICAGO, IL, 60606, US

(73) Assignee: Milestone S.r.I., Sorisole (IT)

(21) Appl. No.: 10/387,601

(22) Filed: Mar. 13, 2003

(30) Foreign Application Priority Data
Jun. 21, 2002 (DE) 102 27 836.9

(51) Int. Cl. H05H 1/02; B01J 19/08

(52) U.S. Cl. 422/186; 427/571

(57) ABSTRACT

For mixing and for initiating chemical reactions of solids, suspensions or emulsions in a microwave instrument, the solids, emulsions or suspensions are introduced into a microwave-transparent container. This microwave-transparent container is then rotated under exposure to microwave radiation, the rotation axis being inclined at an angle with respect to the vertical so as to provide an obliquely oriented container. The solids, suspensions or emulsions which have been introduced are made to undergo the reaction (synthesis) by the input of the microwave.

### FIELD

The present invention relates to a method for mixing and for initiating chemical reactions of solids, suspensions or emulsions in a microwave field, to the use of such a method for coating chromatography support material or for producing catalysts, and to a microwave heating instrument which is designed for carrying out such methods.

### BACKGROUND AND PRIOR ART

The present invention relates quite generally to microwave-assisted chemical processes. In this context, EP 0 628 330 A1 “Oblique rotary evaporator” discloses a rotary evaporator in which an evaporation substance is heated by microwaves in an irradiation chamber of a microwave heating instrument, only the holder and the vessel being situated in the heating chamber. The rotation drive is arranged outside the heating chamber, the holder extending preferably obliquely downwards through the wall of the heating chamber and into it. At least one delivery line as well as a discharge line, for example for continuous delivery of an evaporation substance or optionally also a sample substance and a reagent while discharging vapour, may preferably extend lengthwise on the holder. By means of this, not only does the rotation of the hold and the vessel remain unimpaired, but also it is unnecessary to have any other feed-through openings in the casing enclosing the heating chamber. Owing to the arrangement of the rotation drive outside the heating chamber, it is arranged protected against damage by the microwaves.

Comprehensive reference is hereby made to the disclosure of the said EP 0 628 330 A1 with respect to the mechanical structure of the device explained in it.

The present invention now develops this known device with respect to carrying out the method, but also with regard to design features of the device for the solids synthesis in the microwave field. During the solids synthesis in which, for example, solids mixtures in powder form, suspensions or emulsions are made to undergo reaction with one another, a homogeneous suspension or distribution of the solids is of great importance for carrying out the process correctly. Naturally, this problem arises at most to a much lesser degree in pure evaporation processes.

However, known mechanical stirrers cannot meet the stringent requirements of microwave-assisted chemical processes with respect to the homogeneity of the mixtures. The reason is that during the input of microwaves into solid bodies, the latter are heated from the inside and therefore in homogeneously. The reason for this, in turn, is that the outer regions are in constant heat exchange with the surrounding atmosphere, and are therefore at a lower temperature than the inner region. There must therefore be very highly homogeneous blending in order to guarantee that the reaction is carried out uniformly and, in particular, in order to avoid local overheating in the sample.

A further problem with mechanical stirrers is that parallel processing of a plurality of test tubes when carrying out a process can thereby take place only with difficulty, since one stirrer would in fact have to dip into each of the various test tubes in which the samples are accommodated. In combinatorial analysis, for example, it is often the case that up to 96 test tubes are used at the same time, which quite clearly exceeds the economically viable possibilities of mechanical stirrers.

A further aspect which must always be borne in mind for microwave-assisted chemical procedures is that regions with higher microwave power and, correspondingly, regions with lower microwave power are formed in the microwave space of the heating instrument owing to reflections. Therefore, in order to prevent this inhomogeneous microwave power distribution in the microwave space from leading to inhomogeneous temperature distributions, it is necessary to ensure that the sample, or the samples, reach regions of different power when carrying out the process so that, as a time average, an equal microwave power delivery is obtained for all the samples.

### SUMMARY

It is therefore an object of the invention to provide a technology for initiating chemical reactions of solids, suspensions or emulsions in a microwave field, in which
homogeneous mixing of the solids, suspensions or emulsions, and
homogeneous microwave input onto the sample (N) are guaranteed at the same time.

These two requirements are particularly advantageously achieved according to the present invention by a single measure as follows:

In order to initiate chemical reactions of solids, suspensions or emulsions in a microwave field, the solids, suspensions or emulsions are introduced into a microwave-transparent container. This microwave-transparent container is then rotated under exposure to microwave radiation, the rotation axis being inclined at a fixed or, alternatively, variable (adjustable) angle with respect to the vertical. The rotation of the container with the rotation axis inclined with respect to the vertical ensures, on the one hand, that the solids, suspensions or emulsions reach regions of different microwave power, and are therefore heated homogeneously. At the same time, since the surface of the solids mixtures, suspensions or emulsions, which is inclined at an acute angle with respect to the container, rotates constantly with respect to the container wall, sufficiently homogeneous blending of the said substances is achieved.

In contrast to the known evaporation techniques, the present invention hence blends together at least two substances, which are then intended to undergo reaction with one another. For the first time, the rotation with an obliquely oriented rotation axis is hence used for mixing and not only for increasing the surface area, as is merely the case in evaporation. An instrument according to the invention could therefore be referred to as an “obliquely oriented mixer in the microwave field”.

This method may then be carried out without solvents, or with the use of a weakly polar solvent (for example water) in the case of suspensions or emulsions.

Particularly good homogeneous input of the microwave power and also microwave blending is achieved when the container accommodating the substances rotates eccentrically during the input of the microwave. The region through which the container passes is thereby enlarged in comparison with rotation around its symmetry axis. For example, this can be achieved by fitting the substances, which are intended to undergo the chemical reaction, into a first container which is in turn fitted into a second larger container. The first container, accommodating the substances, is in this case eccentrically accommodated in the second container, the second container being rotated around its mid-axis (which is inclined with respect to the vertical).

In principle, however, it is also possible to put the substances intended to undergo the reaction into a container, which is supported by means of a rotating holder with an inclined rotation axis.

The container, into which the solids, suspensions or emulsions are put, may be flushed with an inert gas or, alternatively, with a reaction gas.

It is particularly advantageous for the container, in which the substances are present, or the second container accommodating this at least one first container, to be held during the rotation only in the upper region, away from the bottom, and to be otherwise free.

The first container, or the second container, may in this case have a lid which is firmly connected to the respective container, and which is pulled upwards by means of vacuum during the rotation and is thereby held.

The solids may, for example, be a molecular sieve in powder form and a means for coating the active surface of the molecular sieve.

A mixture of solids which is in powder form may, in particular, be used.

If a plurality of containers are used, they may be arranged circularly around the inclined rotation axis, which in turn ensures a particularly advantageous eccentric rotation movement.

According to further aspects of the invention, provision is made for the use of such a method to coat chromatography support material or to produce catalysts.

According to yet another aspect of the present invention, a two-stage method is provided for initiating chemical reactions of solids, suspensions or emulsions in a microwave field. To that end, a first solid is initially introduced into a microwave-transparent container, and then heated by microwave irradiation. A further solid is subsequently added into the container, and the container is rotated under exposure to microwave radiation, the rotation axis being inclined at an angle with respect to the vertical.

The first solid may be a molecular sieve whose surface is activated by the heating. The further solid may be a metal in powder form which, through the chemical reaction, covers the thereby activated surface of the molecular sieve.

The further solid may, in particular, be introduced into the container in an environment which is free of water vapour.

The microwave power may in this case be selected to be lower in the step of heating than in the step of initiating the chemical reaction.

The invention furthermore provides for the use of a microwave heating instrument for such methods, as well as a microwave heating instrument which is specified for carrying out such a method.

### BRIEF DESCRIPTION OF THE DRAWINGS

Further features, advantages and properties of the present invention will now be clarified in more detail with reference to the figures of the appended drawings and by explanations of preferred exemplary embodiments.

FIG. 1 shows a microwave heating instrument according to the invention in front view and in schematic representation, and

FIGS. 2 and 3 show modified embodiments of this instrument.

### DETAILED DESCRIPTION OF THE PREFERRED EMBODIMENTS

The main parts of the instrument 1 according to the invention are a holder 2, preferably extending in the manner of a straight arm, for holding a jar-shaped container or vessel 3, or a holder for vessels, a stand 4, on which the holder 2 is mounted so that it can rotate around its longitudinal axis, a rotation drive 5, for rotating the holder 2 around its longitudinal axis in the scope of a continuous rotation or a tilting movement with a periodically alternating rotation direction, an optional suction line 6 and a microwave instrument 7 for initiating reactions of substances in the vessel 3.

As represented, the rotation axis of the vessel 3 is inclined, for example at 45°, with respect to the vertical, so that the surface of the solids mixtures in powder form, emulsions or suspensions in the vessel 3 likewise makes an angle with the bottom surface of the vessel 3. When the vessel 3 is rotated, the surface area enlarged by the oblique attitude hence revolves constantly with respect to the wall of the vessel 3.

The microwave heating instrument 7 has a heating space 8, which is enclosed on all sides by a housing 9, which is cuboid in the present exemplary embodiment and to which a door (not shown) is allocated on its front side for selective opening and closing. The heating instrument 7 furthermore comprises a microwave generator 11 which, after switching on, applies microwaves into the heating space 8 through an application device 12. As explained in detail below, the microwave generator 11 may be driven by a computation unit.

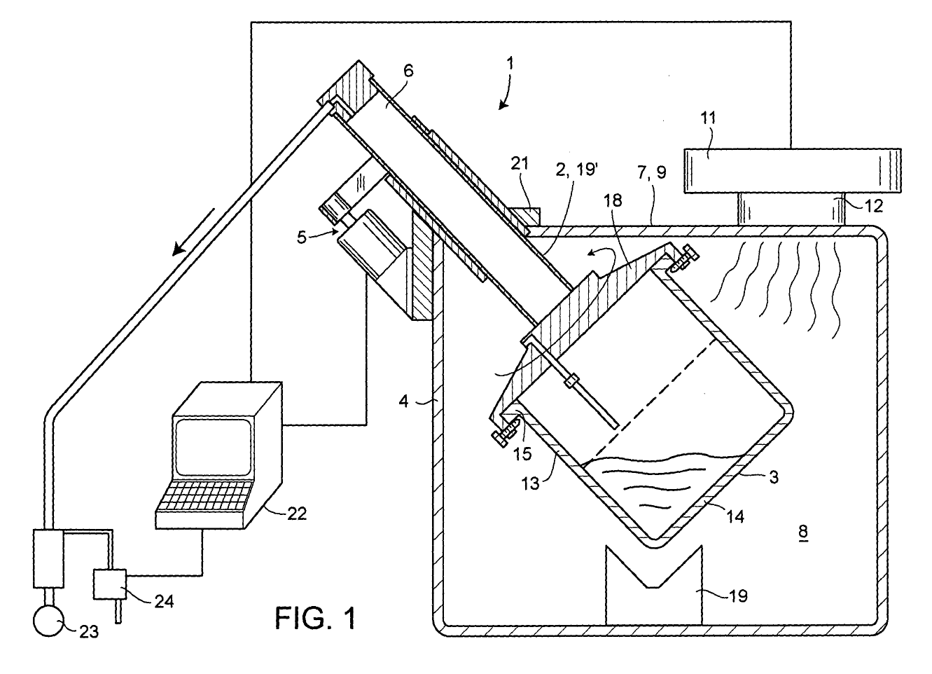

In the exemplary embodiment according to FIG. 1, the vessel 3 is designed in ajar shape with a hollow cylindrical circumferential wall 13, a substantially flat or, alternatively, rounded bottom 14 and an edge flange 15 projecting outwards on the upper edge of the circumferential wall 13. The vessel 3 consists of microwave-transparent material, for example glass, quartz or plastic.

The holder 2 consists of a flange-shaped, closed lid 18 and a bearing shaft 19, which extends in the upper corner region, here on the left, of the housing 9 through an angular reinforcement 21 for the housing 9 and through its wall into the heating space 8. In the present example, the vessel 3 is held during the actual operation by generating a reduced pressure in the suction line 6, so that the lid 18 is suctioned and the vessel 3 is thereby held overall. After the end of the process, the vacuum in the suction line 6 is stepped down, so that the suction action is weakened and the vessel 3 is finally lowered with simultaneous loosening of the holder 2 on a stand 19.

The stand 19 which is represented is fastened on the bottom of the heating space of the microwave instrument and, according to this example, it is designed in two parts, each part of the stand 19 having a beveled upper side with a respectively different inclination, so that the vessel 3 can be held centered in the manner of a funnel.

A computer unit 22 drives the rotation of the rotation drive, the microwave generator 11, a pump 23 for suctioning the line 6 as well as a valve 24, in order to let air flow back into the line according to predetermined process steps.

Instead of being supported by means of the vacuum action in the tube 6, the housing 3 itself, or the lid 18, may naturally also be held by means of screwing, a quick-release attachment or the like.

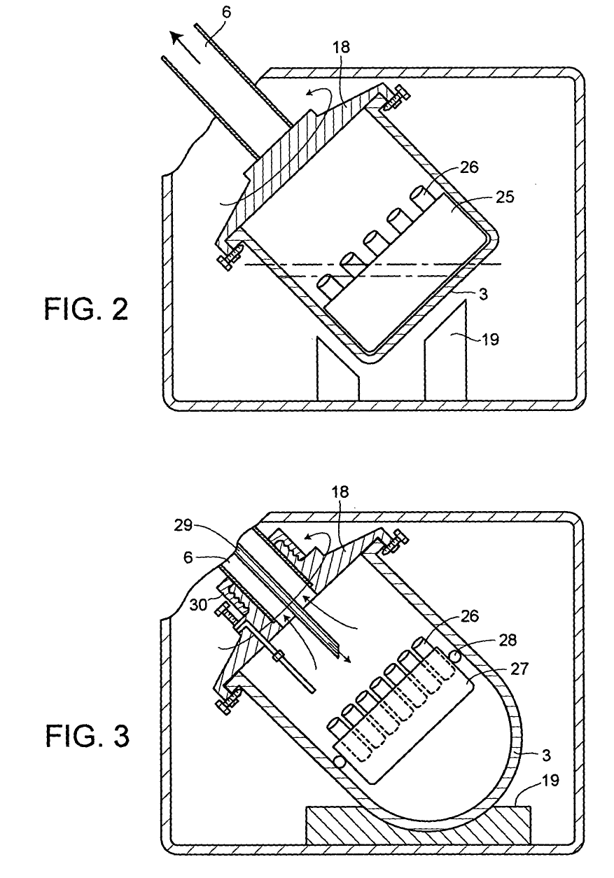

FIG. 2 shows a further exemplary embodiment of the Fig. According to this exemplary embodiment, a holder 25 is fitted into the main vessel 3. This holder accommodates further containers, for example test tubes 26. These test tubes 26 may, in particular, be arranged circularly around the symmetry axis of the main container 3, so that the area passed through by the test tubes in the course of the rotation movement is advantageously enlarged. Each of the samples hence executes a circular movement around the symmetry axis of the main vessel 3, which ensures particularly good homogeneous blending as well as passage through microwave powers of different amplitude in the heating space.

Whereas the holder shown in FIG. 2 is fitted in the bottom of the main vessel 3, FIG. 3 shows an exemplary embodiment in which a holder 27 for the test tubes 26 is inserted into the main vessel 3, and supported, by means of an O-ring or the like.

According to the exemplary embodiment of FIG. 3, it should furthermore be noted that the vessel can be set onto the holder 19 through a mechanical movement of the rotation mount 2. It is furthermore possible, by means of an additional line 29 in the suction line 6, to introduce a gas through the lid 18 into the main container 3. This gas may be either an inert gas, for example a noble gas, or alternatively a reaction gas, for example hydrogen. In order to achieve complete flushing, in this example, the suction line 6 passes completely through the lid 18, in order to suck gas from the interior of the main vessel 3 and therefore to ensure through-flow of the corresponding gas.

Accordingly, the lid 18 is also firmly connected to the rotation mount 2 and the suction line 6 in FIG. 3, for example by means of a flange and a screw connection 30.

As already mentioned, the substances present in the container 3, or the further containers 26, may be solids mixtures in powder form, suspensions or emulsions. At least two substances are hence intended to be mixed intimately together and made to undergo the reaction. When suspensions are being used, it is possible to use a polar or weakly polar solvents with high microwave transparency the obliquely oriented container 3, or the obliquely oriented container system (in the event that further containers 26 are provided in the main container 3) guarantees a homogeneous reaction and prevents, in particular, local overheating in the samples. The microwave radiation which initiates the reaction passes through the vacuum, or the gas, in the container 3 and hence achieves homogeneous heating of all the containers.

Moreover, the microwave power is selected in such a way that the substances are heated sufficiently for reaction with one another.

According to the exemplary embodiment of FIG. 1, the container 3 is kept under slight vacuum, in order to guarantee connection to the rotation axis 2 by the suctioning of its lid 18. This vacuum suction hence has a pure holding function. Alternatively, this holding function may naturally also be provided, for example, by means of the flange screwing shown in FIG. 3. In this case, no vacuum suction is therefore necessary.

In the event that an overpressure may occur in the main container during the reaction, pressure-tight screwing of the lid 18 to the container 3 is accordingly to be provided. In the event that further containers 26 are used in the main container 3, these further containers 26 may also be provided with pressure-tight attachments.

The holder 25 or 27 may, for example, consist of PTFE material, into which corresponding bores are provided.

If the plurality of containers 26 are provided, a parallel synthesis/reaction can be carried out through a single process.

A further advantage of the oblique attitude of the container 3 with respect to the vertical is that this increases the surface area of the liquid phase in the case of suspensions and emulsions, or the surface area of the powder mixtures, in the reagent container.

The present invention has many possible applications. One example is the production of catalysts. In this case, a porous, spongy molecular sieve, for example zeolite, as well as a coating medium, for example gold or palladium, are introduced into the container or the containers 26. By applying the microwave radiation with simultaneous rotation, a homogeneous surface coating of the molecular sieve can be achieved.

A chemical reaction in the scope of the present invention is also the activation, that is to say the mild heating, of substances in order to remove components such as for example water from the surface of the substances, since these components can block the active surface, for example of the molecular sieve of the catalysts. In a first step, the molecular sieve is hence heated mildly. After this activation, a coating medium can be added in a further step in a water-free atmosphere. Lastly, bonding of the coating medium to the active surface then takes place under strong microwave application. This bonding of the coating medium to the active surface is likewise a chemical reaction in the scope of the present invention.

A further case in which the present invention may be used is the coating of support material, such as for example silica gel, for thin layer chromatography.

1. A method for mixing and for initiating chemical reactions of solids, a suspension or an emulsion in a microwave field,
said method comprising the steps of:
introducing the solids, emulsion or suspension into a microwave-transparent container,
rotating the container under exposure to microwave radiation about a rotation axis inclined at an angle with respect to the vertical, and
initiating a chemical reaction of the solids, emulsion or suspension while the container is rotated at said inclined angle under exposure to said microwave radiation.

2. A method according to claim 1, comprising carrying out the method without solvents.

3. A method according to claim 1, comprising moving the container on a circular path around the rotation axis during exposure to said microwave radiation.

4. A method according to claim 1, comprising disposing the solids, emulsion or suspension into at least one first container, and fitting the first container into a second container.

5. A method according to claim 1, comprising flushing the container into which the solids, suspension or emulsion are put with an inert gas.

6. A method according to claim 1 comprising feeding a reaction gas to the container into which the solids, suspension or emulsion are put.

7. A method according to claim 4, wherein the first and second containers have an upper region and a bottom, and wherein said method comprises holding the first or second container during rotation only in the upper region thereof, away from the bottom of the held container, and the held container is otherwise free.

8. A method according to claim 7, wherein the first container has a lid which is firmly connected thereto, and the lid and the first container connected to it is held by means of vacuum during rotation.

9. A method according to claim 1, wherein the solids comprise a molecular sieve in powder form and means for coating the active surface of the molecular sieve.

10. A method according to claim 1, wherein said solids comprise a mixture of solids in powder form.

11. A method according to claim 1, comprising disposing the solids, emulsion or suspension in a plurality of containers arranged circularly around the rotation axis by means of a holding device.

12. A method of coating chromatography support material comprising mixing and reacting the chromatography support material in accordance with claim 1.

13. A method of producing a catalyst comprising mixing and reacting the catalyst in accordance with claim 1.

14. A two stage method for mixing and for initiating chemical reactions of solids mixtures in a microwave field, the method comprising the steps of:
introducing a first solid into a microwave-transparent container,
heating the solid by microwave irradiation,
adding a further solid into the container,
rotating the container about a rotation axis under exposure to microwave radiation, the rotation axis being inclined at an angle with respect to vertical, and
initiating a chemical reaction of the solids while the container is rotated at said inclined angle under exposure to said microwave irradiation.

15. A method according to claim 14, wherein the first solid is a molecular sieve having a surface that is activated by heat generated by the microwave irradiation and the further solid is a metal which, through chemical reaction, coats the activated surface of the molecular sieve.

16. A method according to claim 14, comprising introducing the further solid into the container in an environment which is free of water vapor.

17. A method according to claim 15, wherein a power level of the microwave irradiation is lower in the step of heating than in the step of initiating the chemical reaction.

18. A microwave heating instrument configured for carrying out a method according claim 1.

19. A method according to claim 1, including the step of admixing the solids, suspension or emulsion with a weakly polar solvent.

20. A method according to claim 19, wherein the weakly polar solvent comprises water.

21. A method according to claim 4, wherein the second container has an upper region and a bottom and said method comprises holding the second container only in the upper region thereof, away from the bottom of the second container, and the second container is otherwise free.

22. A method according to claim 21, wherein the first container has a lid which is firmly connected thereto, and the lid and the second container connected to it are held by means of vacuum during rotation.

23. A microwave heating instrument configured for carrying out a method according to claim 14, wherein the microwave heating instrument includes a rotating container holder having an inclined rotation axis adapted to hold a container at an angle that is inclined with respected to vertical, and a drive means for rotating the container.

24. A microwave heating instrument, wherein the heating instrument comprises a housing defining a heating space, said housing including a door; a microwave generator for applying microwave radiation into the heating space; and wherein the container holder comprises a bearing shaft operatively associated with a suction line that enters the heating space from a corner region thereof, said suction line capable of holding the container from an upper portion thereof without the container otherwise contacting the housing.

25. A microwave heating instrument in accordance with claim 24 wherein the suction device creates a vacuum in an upward direction on a container lid to hold the container by the suction applied to the lid.
